(19) United States
(12) Patent Application Publication
(10) Pub. No.: US 2004/0007594 A1
(43) Pub. Date: Jan. 15, 2004

(54) Bonus flavor dispenser

(76) Inventors: Willy Van Esch, Grez-Doiceau (BE); Henrique Braun, Brussels (BE)

Correspondence Address: Daniel J. Warren, SUTHERLAND ASBILL & BRENNAN LLP, 999 Peachtree Street, NE, Atlanta, GA, 30309-3996, US

(21) Appl. No.: 10/191,083

(22) Filed: Jul. 9, 2002

(51) Int. Cl. B67D 5/60

(52) U.S. Cl. 222/145.1

(57) ABSTRACT

A device for adding an amount of a secondary fluid to a primary fluid stream. The device may include an outer shell, an inner compartment for storing the secondary fluid, and a flow path defined between the outer shell and the inner compartment for the primary fluid stream. A flow control device may be positioned within the inner compartment so as to control the amount of the secondary fluid added to the primary fluid stream.

### TECHNICAL FIELD

The present invention relates generally to a dispenser for use with a beverage container and more particularly relates to a device that dispenses a secondary fluid to a primary fluid stream during pouring.

### BACKGROUND OF THE INVENTION

Consumers often desire to add a measure of a secondary or a “bonus” flavor or substance to a beverage. Well known examples include adding cherry or vanilla flavoring to a carbonated soft drink; chocolate syrup to milk; and hazelnut or other flavorings to coffee. Likewise, any numbers of different types of mixed drinks are all well known. Further, certain beverage manufacturers and/or distributors may sell a beverage product in different flavors. For example, adding a cherry flavoring to a Coca-Cola® brand carbonated soft drink has long been a favorite fountain drink. As a result, The Coca-Cola Company of Atlanta, Georgia now markets the “Cherry Coke®” carbonated soft drink with the cherry flavoring pre-mixed in the beverage container.

Although the use of such bonus flavors may promote the popularity of the beverage brand, care must be taken that the identity of the brand is not compromised. For example, the consumer understands what he or she will receive when ordering a carbonated soft drink with the addition of the cherry flavoring or buying a beverage that is clearly marked as a “Cherry Coke®” soft drink. In the case of the “Cherry Coke®” soft drink, the container is clearly marked such that subsequent users or even casual observers will be aware of the nature of the beverage. This understanding, however, may not be present if a consumer adds a flavor to a beverage in a beverage container and then places the beverage container back in the refrigerator. A subsequent user may not be aware of or expect the addition of the flavor. Similarly, a casual observer's expectations or understanding of the nature of the brand also may be changed if the color of the beverage is changed.

This concern with the appearance of the brand is heightened in the case of a clear or a substantially transparent beverage, and particularly when the beverage is contained in a transparent plastic (PET) bottle. The addition of a flavoring may alter the appearance or the color of a clear carbonated soft drink or bottled water. For example, the addition of a cherry flavoring to a bottle of water may change the appearance of the water to a cherry red color. Although the immediate consumer may desire such a cherry flavored water product, the visual impact of the product may alter another consumer's sense of the qualities of the brand.

What is desired, therefore, is a method and an apparatus for adding bonus flavorings, colors, or other types of secondary liquids to beverages or other liquids. The method and the apparatus should provide this bonus liquid without impacting upon the overall image and qualities of the beverage brand as found in the original container. The methods and the apparatus also should be relatively inexpensive to provide to the consumer.

### SUMMARY OF THE INVENTION

The present invention thus provides a device for adding an amount of a secondary fluid to a primary fluid stream. The device may include an outer shell, an inner compartment for storing the secondary fluid, and a flow path defined between the outer shell and the inner compartment for the primary fluid stream. A flow control device may be positioned within the inner compartment so as to control the amount of the secondary fluid added to the primary fluid stream.

Specific embodiments of the present invention may provide for a number of support legs to connect the inner compartment to the outer shell. The inner compartment may include a first end and a second end. The flow control device may include a lid positioned about the first end of the inner compartment. The lid may include an aperture therein. The flow control device also may include a passageway extending from the aperture of the lid to about the second end of the inner compartment. The flow control device may include one or more resilient elements cooperating with the passageway about the second end of the inner compartment. The resilient elements may have a bias towards raising the passageway and the lid of the flow control device beyond the first end of the inner compartment by about a predetermined length. The predetermined length, in combination with the passageway, may provide a venturi effect when the primary fluid flow passes by the first end of the inner compartment. The device further may include an inner compartment enclosure so as to force the flow control device within the inner compartment. The inner compartment enclosure may include a passageway block so as to close the passageway. A number of the devices may be joined and used together, for example, in tandem, or via a manifold-type coupling, side-by-side.

A further embodiment of the present invention may provide a system for adding a secondary fluid to a primary fluid. The system may include a primary fluid container with the primary fluid and a secondary fluid container with the secondary fluid. The secondary fluid container may be positioned in communication with the primary fluid container. The secondary fluid container may include a flow control device for adding a predetermined amount of the secondary fluid to a predetermined amount of the primary fluid.

The primary fluid may be a beverage such as coffee; tea; water; fruit, vegetable and juice concentrates; fruit, vegetable and juice beverages; isotonic beverages; non-isotonic beverages; milk and milk byproducts; carbonated soft drinks; and soft drink concentrate. The secondary fluid may be a beverage enhancer such as coloring, flavoring, nutrients, proteins, carbohydrates, vitamins, minerals, electrolytes, alcohol, carbonation, sweetener (natural or artificial), and similar types of fluids.

The primary fluid container may include a bottle with a mouth. The bottle may include a number of threads surrounding the mouth. The secondary fluid container also may include a number of threads so as to mate with the threads of the bottle.

The secondary fluid container may include an outer shell, an inner compartment, and a flow path defined between the outer shell and the inner compartment. The mouth and the flow path both may have a predetermined cross-sectional area of similar dimension. The flow control device may be venturi effect-type device. The flow control device may be positioned within the inner compartment. The flow control device may include a lid positioned about the first end of the inner compartment. The lid may include an aperture therein. The flow control device may include a passageway extending from the aperture of the lid to about the second end of the inner compartment. The flow control device may include one or more resilient elements cooperating with the passageway about the second end of the inner compartment. The resilient elements may have a bias towards raising the passageway and the lid of the flow control device beyond the first end of the inner compartment by about a predetermined length. The system further may include a secondary compartment enclosure. The secondary compartment enclosure may include a passageway block so as to close the passageway. The system also may use a number of secondary fluid compartments. The primary fluid compartment and the secondary fluid compartment may be a unitary element or a number of elements.

A further embodiment of the present invention may provide a system for adding a secondary fluid to a primary fluid. The secondary fluid may include a primary fluid container containing the primary fluid and a secondary fluid container positioned in communication with the primary fluid container. The secondary fluid container may include an outer element, an inner compartment containing the secondary fluid, and a flow path defined between the outer shell and the inner compartment for adding a predetermined amount of the secondary fluid to a predetermined amount of the primary fluid.

The method of the present invention may provide for combining a secondary fluid contained in a secondary fluid container with a primary fluid contained in a primary fluid container. The method may include the steps of positioning the secondary fluid container in communication with the primary fluid container, pouring the primary fluid through the secondary fluid container, and adding a stream of the secondary fluid to the primary fluid via at least a partial venturi effect. The method further may include the step of positioning a number of the secondary fluid containers in communication with the primary fluid container.

These and other features of the present invention will become apparent upon review of the following detailed description of the preferred embodiments, when taken in conjunction with the drawings and the appended claims.

### BRIEF DESCRIPTION OF THE DRAWINGS

FIG. 1 is a side plan view of a bottle with a bonus flavor compartment of the present invention.

FIG. 2 is a side cross sectional view of the bonus flavor compartment and the bottle of FIG. 1.

FIG. 3 is a top plan view of the bonus flavor compartment with the top cap removed.

FIG. 4 is a side cross sectional view of the bonus flavor compartment.

FIG. 5 is a side plan view of an alternative embodiment of the present invention showing two bonus flavor compartments positioned on a bottle.

### DETAILED DESCRIPTION

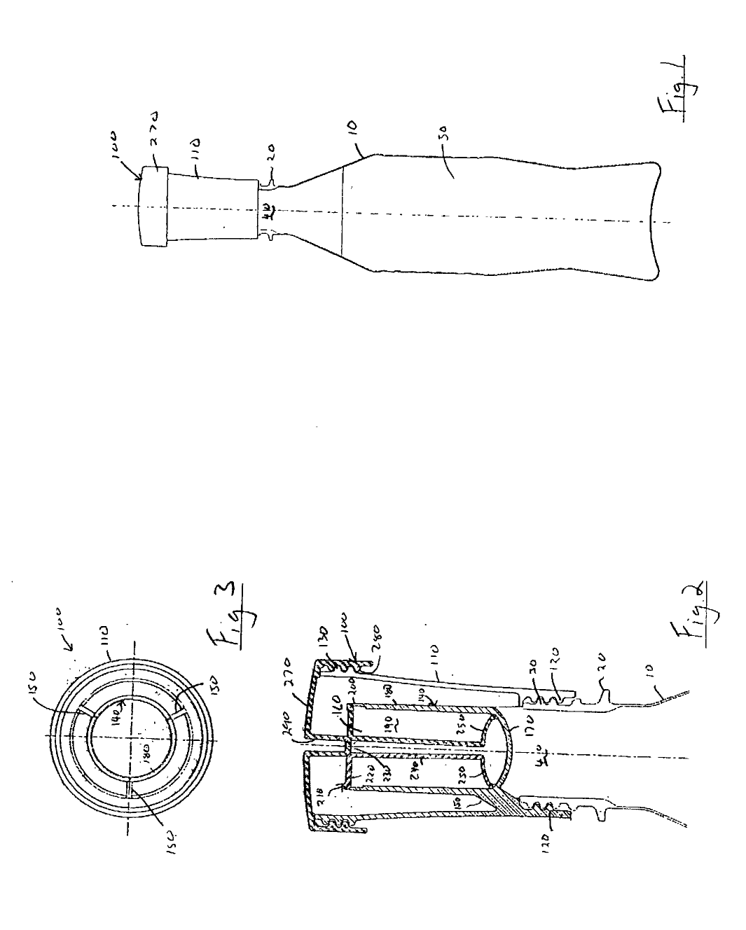

Referring now to the drawings, in which like numerals represent like elements throughout the several views, FIG. 1 shows a bottle 10 for use with the present invention. The bottle 10 may be of conventional design and may be made out of glass, plastic, or other types of conventional materials. As is well, known the bottle 10 may include a support ring 20 and a plurality of threads 30 positioned around a mouth 40. The bottle 10 may come in any convenient size or shape.

For purposed of this example, the bottle 10 may hold about one-half liter of a liquid 50. The liquid 50 may include beverages or any other type of fluids. The beverages may include coffee; tea; water; fruit, vegetable and juice concentrates; fruit, vegetable and juice beverages; isotonic beverages; non-isotonic beverages; milk and milk byproducts; carbonated soft drinks; soft drink concentrate; and the like.

As is shown in FIGS. 1-3, a bonus compartment 100 of the present invention may be positioned on top of the bottle 10. The bonus compartment may hold a measure of a bonus liquid 105. The bonus liquid 105 may be designed to add color, flavoring, carbonation, sweetener, or any other type of additive intended to be mixed with the liquid 50. Specifically, the bonus liquid 105 may be a beverage enhancer such as coloring, flavoring, nutrients, proteins, carbohydrates, vitamins, minerals, electrolytes, alcohol, carbonation, sweetener (natural or artificial), etc. The bonus compartment 100 and the bottle 10 generally are separate elements such that existing bottling equipment and bottling lines may be used to manufacturer and fill the bottle 10. The bonus compartment 100 may then be added at the bottling facility or it may be shipped or sold separately from the bottle 10. A further embodiment of the present invention may include the bonus compartment 100 and the bottle 10 being made of a unitary element, i.e., a single bottle. Further, specific elements of the bonus compartment 100, as described below, may be manufactured with or later affixed to the bottle 10 apart from the remaining components of the bottle 10 as a whole.

The bonus compartment 100 may include an outer shell 110. The outer shell 110 may include a plurality of internal threads 120 positioned on one end thereof. The internal threads 120 may be of conventional design and may be designed to mate with the threads 30 of the mouth 40 of the bottle 10. Alternatively, other types of mating means, such as a snap-on fit, friction fit, interference fit, or other means, also may be used to fix the bonus compartment 100 on the bottle 10. The outer shell 110 also may have a plurality of outer threads 130 positioned on the other end thereof. The outer threads 130 may be of conventional design. Alternative mating means also may be used.

The bonus compartment 100 also may include an inner cylinder 140. The inner cylinder 140 may be supported within the outer shell 110 by one or more support legs 150. The support legs 150 may extend between the outer shell 110 and the inner cylinder 140. In this example, three (3) support legs 150 may be used. The number of support legs 150 may vary. The support legs 150 may hold the inner cylinder 140 fixedly in place. The inner cylinder need not be a true cylinder, rather, could be semi-conical or have slightly radiused walls, with other configurations also being possible.

The inner cylinder 140 may be substantially cup shaped, with an opened first end 160 and a curved second end 170. The inner cylinder 140 may further define a cylinder wall 180 and an interior space 190. The cylinder wall 180 of the inner cylinder 140 may define a support ledge 200 positioned therein and facing the interior space 190.

Positioned within the interior space 190 of the inner cylinder 140 may be a flow control device 210. The flow control device 210 may include a lid 220 that is positioned within the first end 160 of the inner cylinder 140 at about the support ledge 200. The lid 220 may define a center aperture 230. The center aperture 230 may lead to an internal pipette 240. The pipette 240 may be a substantially hollow tube-like structure or a similar type of passageway. The pipette 240 may run substantially the length of the inner cylinder 140. The pipette 240 may include one or more spring legs 250 in contact with the curved second end 170. In this example, three (3) spring legs 250 may be used. The number of spring legs 250 may vary and any number may be used. The spring legs 250 may provide some resiliency to the flow control device 210. Specifically, the spring legs 250 may be biased towards raising the lid 220 of the flow control device 210 within the inner cylinder 140 unless otherwise compressed or restricted.

The outer shell 110, the inner cylinder 140, and the support legs 150 may define a flow path 260 surrounding the inner cylinder 140. The flow path 260 allows the fluid 50 within the bottle 10 to flow out of the bottle mouth 40, past the inner cylinder 140, and out of the bonus compartment 100 when the bottle 10 is rotated for pouring. Preferably, the flow path 260 has about the same area as the mouth 40 of the bottle 10. The use of approximately the same area in the neck and the mouth 40 of the bottle 10 and in the flow path 260 of the bonus compartment 100 provides that the flow characteristics of the liquid 50 in the flow path 260 may be similar to the flow characteristics in the neck of the bottle 10.

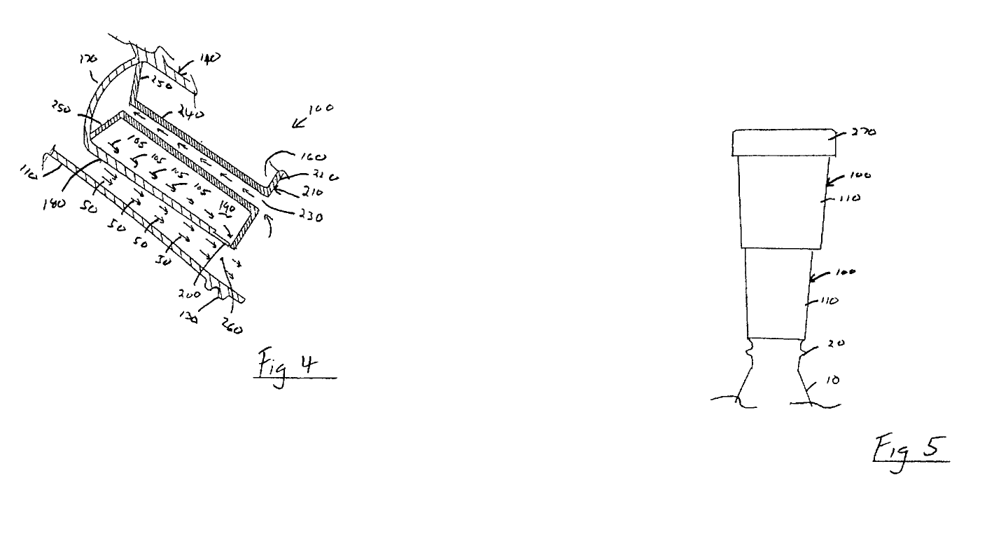

Enclosing the bonus compartment 100 may be a top cap 270. The top cap 270 may include a plurality of inner threads 280. The inner threads 280 may be of conventional design and may mesh with the outer threads 130 of the outer shell 110. Other types of mating means may be used, such as a snap-on device. The top cap 270 also may include a central plug 290. The central plug 290 may be a substantially cylindrical shaped element that largely fits within or blocks the center aperture 230 of the lid 220 of the inner cylinder 140. The central plug 290 may be formed in the top cap 270 as is shown in FIG. 3 or the central plug may be a separate element that is fixedly attached to the top cap 270. Alternatively, the central plug 290 also may be a separate element distinct from the top cap 270.

As is shown in FIG. 2, when the top cap 270 is placed on the outer shell 110 and screwed into place or otherwise attached, the central plug 290 may block the center aperture 230 of the flow control device 210 and force the lid 220 downward along the support ledge 200 of the cylinder wall 180 of the inner cylinder 140. As is shown in FIG. 4, when the top cap 270 is removed from the outer shell 110, the spring legs 250 of the flow control device 210 may force the lid 220 to rise within the inner cylinder such that lid 220 clears the cylinder wall 180 of the inner cylinder 140.

The outer shell 110 of the bonus compartment 100 may have a lower diameter such that the inner threads 120 may mate with the threads 30 of the bottle 10. The outer shell 110 may have an upper diameter such that the outer threads 130 may mate with the threads 280 of the top cap 270.

The elements of the bonus compartment 100 may be made out of suitable thermoplastics such as polyethylene, PET (polyethylene terephthalate), polypropylene, mixtures thereof, or similar materials. The materials should be food grade quality. The elements of the bonus compartment 100 may be made by an extrusion process. Other suitable manufacturing processes include blow molding, injection molding, and similar processes.

Although it is preferred that the bonus compartment 100 contain the bonus liquid 105 for delivering the bonus component, it will now also be appreciated that powders and/or gels (for example in the form of small beads or pellets) could be used to deliver the bonus component. In the case of powders, it may be necessary to add an agent to prevent caking and allow the powder to pour readily through the compartment, it being understood that in such embodiment a venturi effect would not typically occur.

In use, the bonus liquid 105 may be poured into the bonus compartment 100 via the center aperture 230. Alternatively, the bonus liquid 105 may be poured into the inner cylinder 140 and then the flow control device 210 may be positioned therein. The top cap 270 may be then placed on the outer shell 110 so as to seal the center aperture 230 with the central plug 290.

Unless otherwise attached, the bonus compartment 100 may then be attached to the mouth 40 of the bottle 10 via the threads 30, 120. The bottle 10 itself may be sealed with the bonus compartment 100 or the bonus compartment 100 may be shipped separately from the bottle 100, with the bottle 100 being sealed by a cap in a conventional manner. With the top cap 270 in place on the outer shell 110, the bottle 10 and the bonus compartment 100 may be maneuvered in any fashion and even may be turned upside down without the bonus liquid 105 escaping from the bonus compartment 105. The central plug 290 pushes the lid 200 within the cylinder wall 180 of the inner cylinder 140 such that the inner cylinder 140 thus is largely sealed. The bonus liquid 103 cannot escape past the lid 220 or the central plug 290.

Once the bonus compartment 100 is in place on the bottle 10, the user then may remove the top cap 270 from the outer shell 110. In doing so, the central plug 290 is removed from the center aperture 230 of the flow control device 210. The lid 220 of the flow control device 210 thus is forced upward via the spring legs 250. The lid 220 thus clears the cylinder wall 180 of the inner cylinder 140.

When the user begins to pour the liquid 50 out of the bottle 10, the liquid 50 in the flow path 260 may have about the same flow speed and other flow characteristics as the liquid 50 in the neck and mouth 40 of the bottle 10. In the case of syrupy liquids, for example those containing added sweetener, the viscosity of the bonus liquid would tend to be somewhat greater than that of the liquid contained in the bottle, particularly when that liquid is water. As is shown in FIG. 4, the pouring action also causes the bonus liquid 105 to flow up the cylinder wall 180 towards the lid 220. The viscosity of the bonus liquid 105, in connection with the small gap between the cylindrical wall 180 and the lid 220, generally may prevent the bonus liquid 105 from escaping out of the bonus compartment until the liquid 50 flows through the flow path 260 and pass the lid 220. The flowing liquid 50 tends to pull or absorb an appropriate amount of the bonus liquid 105 out of the bonus compartment 100 such that the bonus liquid 105 mixes with the passing liquid 50.

In addition to the liquid 50 attracting or absorbing the bonus liquid 105 as the liquid 50 passes by the lid 220, the bonus liquid 105 also may be forced out of the bonus compartment 100 via at least a partial venturi effect. As the bonus liquid 105 flows from the relatively broad interior space 190 into the relatively narrow opening between the cylinder wall 180 and the lid 220, the venturi effect may provide that the pressure of the liquid 105 may be reduced as the velocity of the bonus liquid 105 increases. This change in pressure may force an air stream 300 into the central aperture 230 and through the pipette 240 of the flow control device 210. This air stream 300 thus may force more of the bonus liquid 105 out of the inner cylinder 140 and into the flow of the liquid 50.

As such, the faster the liquid 50 is poured out of the bottle 10, the faster the bonus liquid 105 may be forced out of the bonus compartment 100 and into the flow of the liquid 50. The bonus compartment 100 thus may provide the appropriate amount or mixture of the bonus liquid 105 regardless of the speed with which the liquid 50 is poured out of the bottle 10. Rather, the amount of the bonus liquid 105 that is added to the flow of the liquid 50 may depend upon the size of the bonus compartment 100 as opposed to the nature of the pour.

When the user returns the bottle 10 to its upright position, the venturi effect may be ended and the bonus liquid 105 generally flows back down the cylinder wall 180. The viscosity of the bonus liquid 105 largely prevents any stray drops of the bonus liquid 105 from dripping down the side of the cylinder wall 180 into the liquid 50 in the bottle 10. Alternatively, the cylinder wall 180 may have a rim or lip thereon to prevent or resist such stray droplets from contacting the liquid 50 remaining in the bottle 10. Such contact may be undesirable in that the bonus liquid 105 may change the appearance or taste of the liquid 50 in the bottle 10.

In an alternative embodiment as is shown in FIG. 5, several bonus compartments 100 may be stacked upon one another so as to mix several bonus liquids 105 with the liquid 50. For example, a bonus liquid 105 used to flavor the liquid 50 may be added to a bonus liquid 105 used to color the liquid 50. Alternatively, several bonus compartments 100 also may be stacked so as to vary the strength or concentration of the bonus liquid 105 added to the liquid 50. Also, several bonus compartments can be connected side-by-side via a manifold-type connector to the bottle.

The use of the bonus compartment 100 with a separate bottle 10 largely ensures that the appearance of the liquid 50 within the bottle 10 remains unchanged. In other words, although the bonus liquid 105 and the liquid 50 will mix together when the bottle 10 is poured, the bonus liquid 105 will have no impact upon the appearance or apparent qualities of the liquid 50 until the bottle 10 is poured. The integrity of the brand of the liquid 50 is maintained while the opportunity to add the bonus liquid 105 is provided. Further, the user may choose to remove the bonus compartment 100 before pouring the liquid 50 out of the bottle 10.

It should be apparent that the foregoing relates only to the preferred embodiments of the present invention and that numerous changes and modifications may be made herein without departing from the spirit and scope of the invention as defined by the following claims and equivalents thereof.

We claim:

1. A device for adding an amount of a secondary fluid to a primary fluid stream, comprising:
an outer shell;
an inner compartment for storing said secondary fluid;
said outer shell and said inner compartment defining a flow path therebetween for said primary fluid stream; and
a flow control device positioned within said inner compartment so as to control said amount of said secondary fluid added to said primary fluid stream.

2. The device of claim 1, wherein said inner compartment comprises a plurality of support legs connecting said inner compartment to said outer shell.

3. The device of claim 1, wherein said inner compartment comprises a first end and a second end.

4. The device of claim 3, wherein said flow control device comprises a lid positioned about said first end of said inner compartment.

5. The device of claim 4, wherein in said lid comprises an aperture therein.

6. The device of claim 5, wherein said flow control device comprises a passageway extending from said aperture of said lid to about said second end of said inner compartment.

7. The device of claim 6, wherein said flow control device comprises one or more resilient elements cooperating with said passageway about said second end of said inner compartment.

8. The device of claim 7, wherein said resilient elements comprise a bias towards raising said passageway and said lid of said flow control device beyond said first end of said inner compartment by about a predetermined length.

9. The device of claim 8, wherein said predetermined length, in combination with said passageway, provides a venturi effect when said primary fluid flow passes by said first end of said inner compartment.

10. The device of claim 8, further comprising an inner compartment enclosure so as to force said flow control device within said inner compartment.

11. The device of claim 10, wherein said inner compartment enclosure comprises a passageway block so as to close said passageway.

12. The device of claim 1, further comprising a plurality of devices joined together.

13. A system for adding a secondary fluid to a primary fluid, comprising:
a primary fluid container containing said primary fluid; and
a secondary fluid container containing said secondary fluid;
said secondary fluid container positioned in communication with said primary fluid container;
said secondary fluid container comprising a flow control device for adding a predetermined amount of said secondary fluid to a predetermined amount of said primary fluid.

14. The system of claim 13, wherein said primary fluid comprises a beverage selected from the group consisting of coffee; tea; water; fruit, vegetable and juice concentrates; fruit, vegetable and juice beverages; isotonic beverages; non-isotonic beverages; milk and milk byproducts; carbonated soft drinks; and soft drink concentrate.

15. The system of claim 13, wherein said secondary fluid comprises one or more beverage enhancers selected from the group consisting of coloring, flavoring, proteins, electrolytes, vitamins, minerals, carbohydrates, carbonation, and sweetener.

16. The system of claim 13, wherein said primary fluid container comprises a bottle with a mouth.

17. The system of claim 16, wherein said bottle comprises a plurality of threads surrounding said mouth.

18. The system of claim 17, wherein said secondary fluid container comprises a plurality of secondary container threads so as to mate with said plurality of threads of said bottle.

19. The system of claim 16, wherein said secondary fluid container comprises an outer shell, an inner compartment, and a flow path defined between said outer shell and said inner compartment.

20. The system of claim 19, wherein said mouth and said flow path both comprise a predetermined cross-sectional area of similar dimension.

21. The system of claim 13, wherein said flow control device comprises a venturi effect device.

22. The system of claim 19, wherein said flow control device is positioned within said inner compartment and wherein said inner compartment comprises a first end and a second end.

23. The system of claim 22, wherein said flow control device comprises a lid positioned about said first end of said inner compartment.

24. The system of claim 23, wherein said lid comprises an aperture therein.

25. The system of claim 24, wherein said flow control device comprises a passageway extending from said aperture of said lid to about said second end of said inner compartment.

26. The system of claim 25, wherein said flow control device comprises one or more resilient elements cooperating with said passageway about said second end of said inner compartment.

27. The device of claim 26, wherein said resilient elements comprise a bias towards raising said passageway and said lid of said flow control device beyond said first end of said inner compartment by about a predetermined length.

28. The system of claim 26, further comprising a secondary compartment enclosure.

29. The system of claim 28, wherein said secondary compartment enclosure comprises a passageway block so as to close said passageway.

30. The system of claim 13, further comprising a plurality of secondary fluid compartments.

31. The system of claim 13, wherein said primary fluid compartment and said secondary fluid compartment comprise a unitary element.

32. The system of claim 13, wherein said primary fluid compartment and said secondary fluid compartment comprise a plurality of elements.

33. A system for adding a secondary fluid to a primary fluid, comprising:
a primary fluid container containing said primary fluid; and
a secondary fluid container positioned in communication with said primary fluid container;
said secondary fluid container comprising an outer element, an inner compartment containing said secondary fluid, and a flow path defined between said outer shell and said inner compartment for adding a predetermined amount of said secondary fluid to a predetermined amount of said primary fluid.

34. A method for combining a secondary fluid contained in a secondary fluid container with a primary fluid contained in a primary fluid container, comprising the steps of:
positioning said secondary fluid container in communication with said primary fluid container;
pouring said primary fluid through said secondary fluid container; and
adding a stream of said secondary fluid to said primary fluid via at least a partial venturi effect.

35. The method of claim 34, further comprising the step of positioning a plurality of said secondary fluid containers in communication with said primary fluid container.
